(19) United States
(12) Patent Application Publication
(10) Pub. No.: US 2026/0167820 A1
(43) Pub. Date: Jun. 18, 2026

(54) ANTIBACTERIAL PLASTIC MASTERBATCH AND ITS APPLICATION IN ANTIBACTERIAL PLASTIC PRODUCTS

(71) Applicant: ANHUI KANGRAN CREATES OXYGEN BIOTECHNOLOGY CO., LTD, Anhui (CN)

(72) Inventors: Mengya LU, Anhui (CN); Dongsheng HUANG, Anhui (CN)

(73) Assignee: ANHUI KANGRAN CREATES OXYGEN BIOTECHNOLOGY CO., LTD, Anhui (CN)

(21) Appl. No.: 18/711,626

(22) PCT Filed: Jan. 24, 2024
(86) PCT No.: PCT/CN2024/073774

§ 371 Date: May 20, 2024

(30) Foreign Application Priority Data
Apr. 3, 2023 (CN) 202310344109.6

(51) Int. Cl. C08L 71/12; C08J 3/22; C08K 5/101; C08K 5/353

(52) U.S. Cl. CPC C08L 71/12; C08J 3/226; C08K 5/101; C08K 5/353

(57) ABSTRACT

This application proposes an antibacterial plastic masterbatch and its application in antibacterial plastic products. The antibacterial plastic masterbatch comprises matrix resin and antibacterial material. Wherein, the antibacterial material is a composite material containing doped magnesium silicate and antibacterial metal. This application proposes an antibacterial plastic masterbatch and its application in antibacterial plastic products. By using doped magnesium silicate and antibacterial metal as antibacterial materials, an antibacterial plastic masterbatch capable of uniformly distributing antibacterial materials and adsorbing and covering the surface of plastic particles was developed. In this way, it can not only ensure the excellent antibacterial effect, but also the antibacterial effect can be sustained for a long time, so as to achieve the effect of continuous preservation.

### CROSS-REFERENCE TO RELATED APPLICATION

The present application claims priority to Chinese patent application NO. 202310344109.6, filed to the Chinese Patent Office on Apr. 3, 2023, entitled “Antibacterial plastic masterbatch and its application in antibacterial plastic products”, the entire disclosure of which is incorporated herein by reference.

### TECHNICAL FIELD

The application relates to the field of plastic product, and in particular, to an antibacterial plastic masterbatch and its application in antibacterial plastic products.

### RELATED ART

With the widespread use of plastics, plastic products have entered all aspects of people's lives, such as food packaging, home appliances, kitchen and bathroom products, automobile accessories and medical equipment. The surface of plastic products in daily life often contains a lot of bacteria, which has become a medium of disease-infected, which pose a great threat to human health and life.

As the name suggests, antibacterial plastic is to add a certain amount of antibacterial materials to the plastic to make it antibacterial performance without losing its original conventional performance and processing performance. At present, there are many kinds of antibacterial materials, comprising inorganic antibacterial materials and organic antibacterial materials. Inorganic materials comprise silver/zinc-zeolite, silver/zinc-zirconium phosphate, silver/zinc-glass, etc., and organic materials comprise quaternary amine salt, quaternary phosphine salt, imidazole class, pyridine class, organic metal class, etc.

The advantage of organic antibacterial materials is that sterilization is fast, but because most of them are small molecular compounds, there are shortcomings including poor heat resistance, easy to fail after aging, easy to make out from the surface of the plastic and impact on the appearance of the products. Due to the advantages of high safety and heat resistance, inorganic antibacterial materials the market share has increased year by year. However, the antibacterial plastic obtained by adding such antibacterial materials directly on the market does not have an efficient, long-term, and broad-spectrum antibacterial effect. This is mainly because: First, because of the properties of plastic hydrophobic and oleophobic, generally single inorganic or complex organic antibacterial material and plastic is not available to decentralized and attachment packaging. The antibacterial materials cannot be on the surface of the antibacterial plastic particles in the attached bag. Therefore, no matter how many antibacterial material is added, it cannot be dispersed in plastic and the antibacterial material cannot be wrapped in the plastic, which is easy to be lost; second, because plastic polymer materials produce the characteristics of copolymer film forming into glue, antibacterial material is usually closed in the copolymer layer and cannot be transferred out. The antibacterial material is isolated by the layer and cannot contact the bacteria, of course, it can not play the role of antibacterial sterilization; third, ordinary antibacterial material has positive/negative potential properties, which are incompatible with the nature of the plastic itself that is prone to static electricity, and are difficult to carry, and naturally do not have antibacterial and bactericidal effects. At present, these three major drawbacks are the main reasons why the so-called antibacterial plastics in the current market cannot achieve antibacterial, sterilization, and reach the preservation effect.

### SUMMARY OF INVENTION

Based on the technical problems, this application proposes an antibacterial plastic masterbatch and its application in antibacterial plastic products. By using doped magnesium silicate and antibacterial metal as antibacterial material, an antibacterial plastic masterbatch capable of uniformly distributing antibacterial material and adsorbing and covering the surface of plastic particles was developed. In this way, it can not only ensure the excellent antibacterial effect, but also the antibacterial effect can be sustained for a long time, so as to achieve the effect of continuous preservation.

This application proposes an antibacterial plastic masterbatch, comprising matrix resin and antibacterial material; wherein, the antibacterial material is a composite material containing doped magnesium silicate and antibacterial metal.

Wherein, the doped magnesium silicate is at least one of lithium magnesium silicate, magnesium aluminum silicate, magnesium fluorosilicate, lithium magnesium fluorosilicate or magnesium aluminum fluorosilicate; the antibacterial metal is at least one of silver, copper, zinc, nickel, zinc oxide or titanium oxide.

Wherein, based on the total weight of the antibacterial plastic masterbatch, the content of the antibacterial material is 0.1-10 wt %.

In this application, the doped magnesium silicate has strong bonding and accumulation capabilities and adsorption of bridge. After composited with the antibacterial metal, the antibacterial metal can be adsorbed and wrapped on the surface layer of plastic granules, so as to play an effective antibacterial and bactericidal effect; it can be seen that this application can not only obtain good antibacterial properties, but also form a good compatibility and comprehensive package with the matrix resin by selecting a specific type of antibacterial material, which meets the needs of obtaining antibacterial plastic masterbatch.

Wherein, the doped magnesium silicate is a doped magnesium silicate modified by a non-ionic surfactant; the non-ionic surfactant is preferably at least one of lauroyl diethanolamine, toctyl phenoxy polyethoxy ethanol or polysorbate-20.

Wherein, based on the weight of the doped magnesium silicate, the content of the non-ionic surfactant is 0.1-5 wt %.

In this application, non-ionic surfactant is used for the surface modification of doped magnesium silicate. The surface of doped magnesium silicate is combined with non-ionic surfactant, so that the surface of doped magnesium silicate is transformed into non-polar state, which ensures that the doped magnesium silicate can form better compatibility with the matrix resin and further improves the long-term bactericidal and antibacterial properties.

Wherein, the antibacterial material is obtained by fully mixing a doped magnesium silicate and an antibacterial metal.

Wherein, the weight ratio of doped magnesium silicate and antibacterial metal is 1:0.01-0.05.

Wherein, the matrix resin is at least one of polyethylene, polypropylene, polystyrene, polyvinyl chloride, polymethyl methacrylate, polyacrylonitrile-butadiene-styrene, nylon, polycarbonate, polyurethane, phenolic resin, urea-formaldehyde resin, polyethylene terephthalate or polyformaldehyde.

In this application, the matrix resin used in the antibacterial plastic masterbatch can be a plastic material commonly used in this field, and the resulting antibacterial plastic masterbatch can be used in a variety of plastic products. Different matrix resins can be adapted to plastic products with different resin raw materials; and the content of the matrix resin in the above range can be changed according to the actual application and the specific environment; various types of matrix resins can also be obtained by commercial purchase.

Wherein, the matrix resin further comprises a degradable resin. The degradable resin is preferably at least one of polycaprolactone, cellulose acetate, polybutylene succinate, polyester powder, corn starch, hydroxypropyl starch ether, hydroxypropyl cellulose or starch phosphate.

Wherein, based on the weight of the matrix resin, the content of the degradable resin is 20-50 wt %.

In this application, the degradable resin can not only endow the antibacterial plastic masterbatch with good biodegradability, but also play a role in film forming, reduce environmental pollution, and reduce the production cost of plastic products.

Wherein, the antibacterial plastic masterbatch further comprises inorganic filler; the inorganic filler is preferably at least one of calcium carbonate, active kaolin, nano barium sulfate, oily talcum powder, titanium dioxide, precipitated barium sulfate, magnesium hydroxide or wollastonite powder.

Wherein, based on the total weight of the antibacterial plastic masterbatch, the content of the inorganic filler is 10-50 wt %.

In this application, the inorganic filler not only acts as a filler to improve the mechanical properties, but also plays a film-forming role and enhances the film-forming effect. The content of the inorganic filler can also change according to the actual application and the specific environment in the above range; and various types of inorganic fillers can be obtained through commercial purchase; it should be noted that the inorganic filler is optional, and when the antibacterial plastic masterbatch does not add inorganic fillers, it will not affect its role and efficacy.

Wherein, the antibacterial plastic masterbatch further comprises a functional additive, and the functional additive preferably comprises at least one of the dispersant, compatibilizer, plasticizer, antistatic agent, antioxidant or light stabilizer.

Wherein, the dispersant is at least one of polyethylene wax, polystyrene wax, stearic acid, calcium stearate, magnesium stearate or fatty acid.

Wherein, the compatibilizer is at least one of ethylene-maleic anhydride copolymer, ethylene-acrylic acid copolymer, propylene-maleic anhydride copolymer, propylene-acrylic acid copolymer, maleic anhydride polypropylene graft, acrylic polypropylene graft, silane coupling agent or titanate coupling agent.

Wherein, the plasticizer is at least one of dibutyl phthalate, dioctyl phthalate, dioctyl sebacate, diisodecyl phthalate, epoxidized soybean oil or epoxidized butyl oleate;

Wherein, the antistatic agent is at least one of conductive acetylene carbon black, lauric acid diethanolamide, sodium sulfonate, antistatic agent SN, antistatic agent HK or antistatic agent HZ-1.

Wherein, the antioxidant is at least one of antioxidant 1010, antioxidant DLTP, antioxidant CA, antioxidant 168 or octadecyl thiodipropionate.

Wherein, the light stabilizer is at least one of tris (1,2,2,6,6-pentamethylpiperidinyl) phosphite, 4-tert-butylphenyl salicylate, 2-hydroxy-4-methoxybenzophenone, 2-hydroxy-4-n-octyloxybenzophenone or 4-benzoyloxy-2,2,6,6-tetramethylpiperidine.

Wherein, based on the total weight of the antibacterial plastic masterbatch, the content of the functional additive is 1-30 wt %.

In this application, dispersant can help to further disperse the antibacterial materials, reduce the use of antibacterial materials and reduce the friction during processing; compatibilizer makes the compatibility between the antibacterial material and the matrix resin better, and can also reduce the amount of antibacterial material; other functional additives can also play its inherent properties; this application can add various functional additives to the antibacterial plastic masterbatch according to the needs of specific processing, and its dosage can be adjusted according to the requirements of the actual situation.

Wherein, the antibacterial plastic masterbatch is obtained by mixing the above matrix resin and the antibacterial material, and then extruding and granulating.

In this application, the preparation process of the antibacterial plastic masterbatch is that the matrix resin and the antibacterial material are pre-mixed by a mixer, and then extruded by a twin-screw mixer to obtain the antibacterial plastic masterbatch.

This application proposes a use of the above-mentioned antibacterial plastic masterbatch in antibacterial plastic products.

Wherein, the antibacterial plastic products comprises the antibacterial plastic masterbatch and resin raw materials.

Wherein, the resin raw material is at least one of polyethylene resin, polypropylene resin, ABS resin, nylon resin, polyvinyl chloride resin, EVA resin or polystyrene resin.

Wherein, the weight ratio of the antibacterial plastic masterbatch and the resin raw material is 1:1-100.

Wherein, the preparation process of the bacterial plastic product is to first add the above antibacterial plastic masterbatch to the resin raw material of the plastic, and then process the conventional plastic to obtain the antibacterial plastic product.

The beneficial effects of this application are as follow:

In this application, the antibacterial material is a composite material containing doped magnesium silicate and antibacterial metal. Due to the special properties of a large amount of water network structure after copolymerization of doped magnesium silicate, it is common and compatible with polymer plastic materials. Therefore, the doped magnesium silicate can be uniformly dispersed in the plastic by using the compatibility of the doped magnesium silicate and the matrix resin; at the same time, the antibacterial metal is implanted into the doped magnesium silicate salt by mixing in advance. The doped magnesium silicate can be used as the carrier of the antibacterial metal, carrying the antibacterial metal particles into the water network structure of the magnesium lithium silicate gel film. Finally, the antibacterial metal is uniformly distributed, adsorbed and covered on the surface of the plastic particles, and then the two are more fully dispersed by the stirring process of the granulator, and finally fused with the plastic of the polymer copolymer; therefore, it not only solves the problem that traditional antibacterial materials are difficult to adhere to or isolated by plastic copolymer film, resulting in the inability to exert antibacterial effects, but also in the presence of doped magnesium silicate carriers, antibacterial metals are not charged and very stable. Therefore, it can not only follow the positive potential but also follow the negative potential. In this way, even if the plastic is involved in electromagnetic induction to produce static electricity due to production, handling, contact, separation, friction, collision and even wind force, the generated static electricity will not repel the antibacterial material, and it can just carry the antibacterial metal with excellent stability to migrate out, so as to play a more effective bactericidal effect.

At the same time, compared with the production of traditional antibacterial plastic products, the antibacterial material is directly mixed with plastic particles and then melted and molded, which leads to the fact that the antibacterial material cannot be effectively dispersed in the plastic products. Moreover, due to the easy agglomeration of antibacterial agents, the polymer resin polymers of plastics also encapsulate and block the antibacterial material, resulting in extremely low antibacterial efficiency and inability to exert antibacterial effects. This antibacterial plastic masterbatch was developed in this application; on the one hand, through the compatibility design of antibacterial material, the antibacterial material can be well compatible with the matrix resin, and the antibacterial active ingredients can be uniformly distributed on the surface of the plastic particles, so as to effectively exert the antibacterial effect; on the other hand, compared with the direct blending of antibacterial material and resin raw material to prepare antibacterial plastic products, the antibacterial plastic masterbatch was first prepared in this application, and then blended with resin raw materials to prepare antibacterial plastic products. The latter can further ensure that the antibacterial material is well dispersed, and the antibacterial properties of the obtained antibacterial plastic products are further improved.

### BRIEF DESCRIPTION OF DRAWINGS

FIG. 1 is a comparison chart of the preservation effect of green vegetables placed on the antibacterial plastic products obtained by Embodiment 1 and Comparison 1 for 8 days respectively;

FIG. 2 is a comparison chart of the preservation effect of green vegetables placed on the antibacterial plastic products obtained by Embodiment 1 and Comparison 1 for 16 days respectively.

### DESCRIPTION OF EMBODIMENTS

In the following, this application explains the technical scheme in detail through specific embodiments, but these embodiments should be clearly put forward for illustration, but they are not interpreted as limiting the scope of this application.

### Embodiment 1

This embodiment proposes an antibacterial plastic masterbatch, which is prepared by the following method:
(1) Lithium magnesium silicate and elemental silver were added to a hot air circulation spray dryer according to the weight ratio of 1:0.03, and a spray head nozzle was used to circulate the atomization so that the two were dispersed and mixed evenly to obtain an antibacterial material;
(2) 2 weight parts of the above antibacterial material, 96 weight parts of polyethylene resin and 2 weight parts of polyethylene wax were added into a blender to mix evenly, and then added into a twin-screw extruder to extrude and granulate. The processing temperature of the twin-screw extruder was 180° C., that is, the antibacterial plastic masterbatch was prepared.

### Embodiment 2

This embodiment proposes an antibacterial plastic masterbatch, which is prepared by the method described in embodiment 1, except that in step (1), magnesium aluminum silicate and elemental silver are added to a hot air circulation spray dryer at a weight ratio of 1:0.03.

### Embodiment 3

This embodiment proposes an antibacterial plastic masterbatch, which is prepared by the method described in embodiment 1, except that in step (1), Lithium magnesium fluorosilicate and elemental silver are added to a hot air circulation spray dryer at a weight ratio of 1:0.03.

### Embodiment 4

This embodiment proposes an antibacterial plastic masterbatch, which is prepared by the method described in embodiment 1, except that in step (1), lithium magnesium silicate and elemental zinc are added to a hot air circulation spray dryer at a weight ratio of 1:0.03.

### Embodiment 5

This embodiment proposes an antibacterial plastic masterbatch, which is prepared by the method described in embodiment 1, except that in step (2), 2 parts of the above antibacterial material, 96 parts of polypropylene resin and 2 parts of polyethylene wax are added to the blender.

### Embodiment 6

This embodiment proposes an antibacterial plastic masterbatch, which is prepared by the following method:
(1) lithium magnesium silicate was grinded and added into water to disperse evenly, and then lauroyl diethanolamine with 2.3 wt % weight of the lithium magnesium silicate was added. After stirring and mixing for 1 h, it was filtered and dried to obtain a non-ionic surfactant modified lithium magnesium silicate;
(2) Non-ionic surfactant modified magnesium lithium silicate and elemental silver were added to a hot air circulation spray dryer according to the weight ratio of 1:0.03, and the two were dispersed and mixed evenly by using a nozzle of the spray head to obtain an antibacterial material;
(3) 2 weight parts of the above antibacterial material, 96 weight parts of polyethylene resin and 2 weight parts of polyethylene wax were added into a blender to mix evenly, and then added into a twin-screw extruder to extrude and granulate. The processing temperature of the twin-screw extruder was 180° C., that is, the antibacterial plastic masterbatch was prepared.

### Comparison 1

This comparison proposes an antibacterial plastic masterbatch, which is prepared by the following method:
(1) Nano-zirconium phosphate and elemental silver were added to a hot air circulation spray dryer according to the weight ratio of 1:0.03, and a spray head nozzle was used to circulate the atomization so that the two were dispersed and mixed evenly to obtain an antibacterial material;
(2) 2 weight parts of the above antibacterial materials, 96 weight parts of polyethylene resin and 2 weight parts of polyethylene wax were added into a blender to mix evenly, and then added into a twin-screw extruder to extrude and granulate. The processing temperature of the twin-screw extruder was 180° C., that is, the above antibacterial plastic masterbatch was prepared.

### Comparison 2

This comparison proposes an antibacterial plastic masterbatch, which is prepared by the following method:
(1) Zeolite and elemental silver were added to a hot air circulation spray dryer according to the weight ratio of 1:0.03, and a spray head nozzle was used to circulate the atomization so that the two were dispersed and mixed evenly to obtain an antibacterial materials;
(2) 2 weight parts of the above antibacterial material, 96 weight parts of polyethylene resin and 2 weight parts of polyethylene wax were added into a blender to mix evenly, and then added into a twin-screw extruder to extrude and granulate. The processing temperature of the twin-screw extruder was 180° C., that is, the antibacterial plastic masterbatch was prepared.

### Experimentation

The antibacterial plastic masterbatches prepared by the Embodiment 1-6 and the Comparison 1-2 were mixed with the corresponding resin raw materials respectively, and then the injection molding was carried out to prepare the antibacterial plastic products. The weight ratio of the antibacterial plastic masterbatch to the resin raw material was 1:10; for example, in actual operation, the antibacterial plastic masterbatch and PE resin described in Embodiment 1 could be added to a blender at a weight ratio of 1:10 to mix evenly at high speed, and then blown by a film blowing machine to obtain an antibacterial plastic products.

The antibacterial properties of the antibacterial plastic products obtained above were tested. The test method was: GB/T 31402-2015 Test method for antibacterial properties of plastic surface. The bacteria for detection were: Escherichiacoli (ATCC 25922); Staphylococcus aureus (ATCC 6538); Helicobacter pylori (ATCC43504). Wherein, the calculation formula of antibacterial rate is: antibacterial rate %=(the number of bacteria after n hours of a pure resin sample−the number of bacteria after n hours of the corresponding embodiment or comparison)/the number of bacteria after n hours of the pure resin sample*100%, the test results are shown in Tables 1 and 2 below.

TABLE 1
Antibacterial effect comparison table of antibacterial plastic
products obtained by proportion embodiments and comparisons

| | | Number | 2 h | 24 h |
|---|---|---|---|---|
| Bacterial | | of initial | antibacterial | antibacterial |
| species | Sample | bacteria(CFU/ml) | rate (%) | rate (%) |
| Staphylococcus | Embodiment 1 | 3.9 × 10³ | 99.99 | 99.99 |
| aureus | Embodiment 2 | 3.9 × 10³ | 98.45 | 99.99 |
| | Embodiment 3 | 3.9 × 10³ | 97.56 | 99.99 |
| | Embodiment 4 | 3.9 × 10³ | 99.23 | 99.99 |
| | Embodiment 5 | 3.9 × 10³ | 99.99 | 99.99 |
| | Embodiment 6 | 3.9 × 10³ | 99.99 | 99.99 |
| | Comparison 1 | 3.9 × 10³ | 84.74 | 97.72 |
| | Comparison 2 | 3.9 × 10³ | 81.25 | 96.62 |
| Escherichiacoli | Embodiment 1 | 2.5 × 10³ | 99.99 | 99.99 |
| | Embodiment 2 | 2.5 × 10³ | 99.12 | 99.99 |
| | Embodiment 3 | 2.5 × 10³ | 98.69 | 99.99 |
| | Embodiment 4 | 2.5 × 10³ | 99.99 | 99.99 |
| | Embodiment 5 | 2.5 × 10³ | 99.99 | 99.99 |
| | Embodiment 6 | 2.5 × 10³ | 99.99 | 99.99 |
| | Comparison 1 | 2.5 × 10³ | 90.35 | 99.99 |
| | Comparison 2 | 2.5 × 10³ | 84.67 | 98.37 |
| Helicobacter | Embodiment 1 | 3.1 × 10³ | 99.99 | 99.99 |
| pylori | Embodiment 2 | 3.1 × 10³ | 97.23 | 99.99 |
| | Embodiment 3 | 3.1 × 10³ | 95.45 | 99.99 |
| | Embodiment 4 | 3.1 × 10³ | 98.82 | 99.99 |
| | Embodiment 5 | 3.1 × 10³ | 99.99 | 99.99 |
| | Embodiment 6 | 3.1 × 10³ | 99.99 | 99.99 |
| | Comparison 1 | 3.1 × 10³ | 80.97 | 93.43 |
| | Comparison 2 | 3.1 × 10³ | 75.34 | 91.16 |

TABLE 2
Antibacterial persistence comparison table of antibacterial plastic
products obtained by proportion embodiments and comparisons

| Bacterial | | Antibacterial rate |
|---|---|---|
| species | Sample | after 1 year of use(%) |
| Staphylococcus | Embodiment 1 | 99.24 |
| aureus | Embodiment 2 | 97.21 |
| | Embodiment 3 | 96.35 |
| | Embodiment 4 | 98.47 |
| | Embodiment 5 | 99.02 |
| | Embodiment 6 | 99.99 |
| | Comparison 1 | 73.45 |
| | Comparison 2 | 65.23 |
| Escherichiacoli | Embodiment 1 | 99.45 |
| | Embodiment 2 | 98.12 |
| | Embodiment 3 | 97.69 |
| | Embodiment 4 | 99.11 |
| | Embodiment 5 | 99.37 |
| | Embodiment 6 | 99.99 |
| | Comparison 1 | 78.64 |
| | Comparison 2 | 72.34 |
| Helicobacter | Embodiment 1 | 98.89 |
| pylori | Embodiment 2 | 96.45 |
| | Embodiment 3 | 97.21 |
| | Embodiment 4 | 98.45 |
| | Embodiment 5 | 98.68 |
| | Embodiment 6 | 99.99 |
| | Comparison 1 | 70.23 |
| | Comparison 2 | 61.47 |

It can be seen from the results of Table 1-2 that the antibacterial plastic masterbatch and antibacterial plastic products in this application have good antibacterial effect and long-term effect.

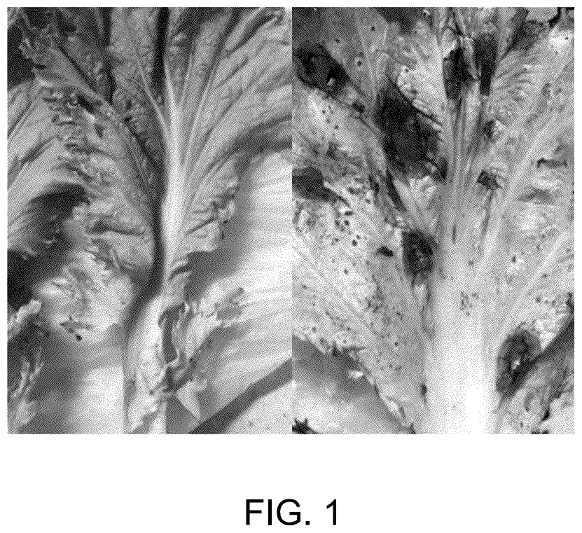

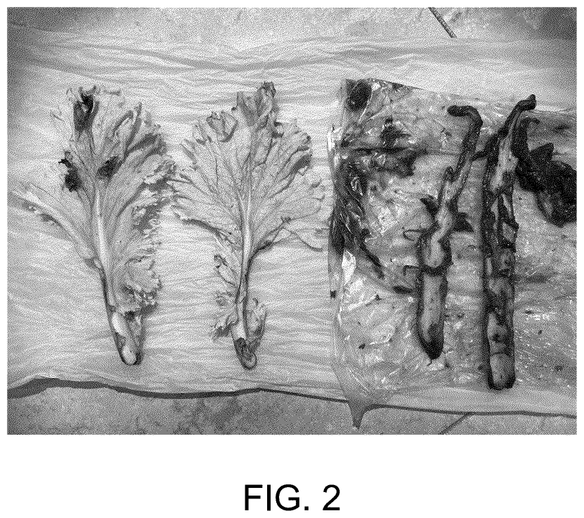

Further, with reference to FIG. 1 and FIG. 2, it can be seen that after placing fresh green vegetables on the antibacterial plastic products obtained from Embodiment 1 and Comparison 1 respectively, after 8 days and 16 days, the green vegetables on the left side (antibacterial plastic products obtained from Embodiment 1) are much fresher than those on the right side (antibacterial plastic products obtained from Comparison 1). It shows that the antibacterial plastic masterbatch and antibacterial plastic products in this application can not only ensure the excellent antibacterial effect, but also the antibacterial effect can be sustained for a long time, so as to achieve the effect of continuous preservation.

The above is only the preferred embodiment of the present application, but the scope of protection of the present application is not limited thereto, and any equivalents or modifications of the technical solutions of the present application and the application concept thereof should be comprised in the scope of the present application within the scope of the technical scope of the present application.

1. An antibacterial plastic masterbatch, comprising matrix resin and antibacterial material;
wherein, the antibacterial material is a composite material containing doped magnesium silicate and antibacterial metal.

2. The antibacterial plastic masterbatch according to claim 1, wherein the doped magnesium silicate is at least one of lithium magnesium silicate, magnesium aluminum silicate, magnesium fluorosilicate, lithium magnesium fluorosilicate or magnesium aluminum fluorosilicate; the antibacterial metal is at least one of silver, copper, zinc, nickel, zinc oxide or titanium oxide.

3. The antibacterial plastic masterbatch according to claim 1, wherein the doped magnesium silicate is a doped magnesium silicate modified by a non-ionic surfactant;
the non-ionic surfactant is preferably at least one of lauroyl diethanolamine, toctyl phenoxy polyethoxy ethanol or polysorbate-20.

4. The antibacterial plastic masterbatch according to claim 3, wherein based on a weight of the doped magnesium silicate, a content of the non-ionic surfactant is 0.1-5 wt %.

5. The antibacterial plastic masterbatch according to claim 1, wherein based on a total weight of the antibacterial plastic masterbatch, a content of the antibacterial material is 0.1-10 wt %.

6. The antibacterial plastic masterbatch according to claim 1, wherein the antibacterial material is obtained by fully mixing the doped magnesium silicate and the antibacterial metal;
a weight ratio of the doped magnesium silicate and the antibacterial metal is 1:0.01-0.05.

7. The antibacterial plastic masterbatch according to claim 1, wherein the matrix resin is at least one of polyethylene, polypropylene, polystyrene, polyvinyl chloride, polymethyl methacrylate, polyacrylonitrile-butadiene-styrene, nylon, polycarbonate, polyurethane, phenolic resin, urea-formaldehyde resin, polyethylene terephthalate or polyformaldehyde.

8. The antibacterial plastic masterbatch according to claim 7, wherein the matrix resin further comprises a degradable resin, the degradable resin is preferably at least one of polycaprolactone, cellulose acetate, polybutylene succinate, polyester powder, corn starch, hydroxypropyl starch ether, hydroxypropyl cellulose or starch phosphate.

9. The antibacterial plastic masterbatch according to claim 8, wherein based on a weight of the matrix resin, a content of the degradable resin is 20-50 wt %.

10. The antibacterial plastic masterbatch according to claim 1, wherein the antibacterial plastic masterbatch further comprises an inorganic filler; the inorganic filler is preferably at least one of calcium carbonate, active kaolin, nano barium sulfate, oily talcum powder, titanium dioxide, precipitated barium sulfate, magnesium hydroxide or wollastonite powder.

11. The antibacterial plastic masterbatch according to claim 10, wherein based on a total weight of the antibacterial plastic masterbatch, a content of the inorganic filler is 10-50 wt %.

12. The antibacterial plastic masterbatch according to claim 1, wherein the antibacterial plastic masterbatch further comprises a functional additive, and the functional additive comprises at least one of dispersant, compatibilizer, plasticizer, antistatic agent, antioxidant or light stabilizer.

13. The antibacterial plastic masterbatch according to claim 12, wherein the dispersant is at least one of polyethylene wax, polystyrene wax, stearic acid, calcium stearate, magnesium stearate or fatty acid;
the compatibilizer is at least one of ethylene-maleic anhydride copolymer, ethylene-acrylic acid copolymer, propylene-maleic anhydride copolymer, propylene-acrylic acid copolymer, maleic anhydride polypropylene graft, acrylic polypropylene graft, silane coupling agent or titanate coupling agent;
the plasticizer is at least one of dibutyl phthalate, dioctyl phthalate, dioctyl sebacate, diisodecyl phthalate, epoxidized soybean oil or epoxidized butyl oleate;
the antistatic agent is at least one of conductive acetylene carbon black, lauric acid diethanolamide, sodium sulfonate, antistatic agent SN, antistatic agent HK or antistatic agent HZ-1;
the antioxidant is at least one of antioxidant 1010, antioxidant DLTP, antioxidant CA, antioxidant 168 or octadecyl thiodipropionate;
the light stabilizer is at least one of tris (1,2,2,6,6-pentamethylpiperidinyl) phosphite, 4-tert-butylphenyl salicylate, 2-hydroxy-4-methoxybenzophenone, 2-hydroxy-4-n-octyloxybenzophenone or 4-benzoyloxy-2,2,6,6-tetramethylpiperidine.

14. The antibacterial plastic masterbatch according to claim 12, wherein based on a total weight of the antibacterial plastic masterbatch, a content of the functional additive is 1-30 wt %.

15. The antibacterial plastic masterbatch according to claim 1, wherein the antibacterial plastic masterbatch is obtained by mixing the above matrix resin and the antibacterial material, and then extruding and granulating.

16. A use of the antibacterial plastic masterbatch according to claim 1 in antibacterial plastic products.

17. The use of the antibacterial plastic masterbatch in antibacterial plastic products according to claim 16, wherein the antibacterial plastic products comprises the antibacterial plastic masterbatch and resin raw material.

18. The use of the antibacterial plastic masterbatch in antibacterial plastic products according to claim 16, wherein the resin raw material is at least one of polyethylene resin, polypropylene resin, ABS resin, nylon resin, polyvinyl chloride resin, EVA resin or polystyrene resin.

19. The use of the antibacterial plastic masterbatch in antibacterial plastic products according to claim 18, wherein a weight ratio of the antibacterial plastic masterbatch and the resin raw material is 1:1-100.
